(19) United States
(12) Patent Application Publication
(10) Pub. No.: US 2009/0260758 A1
(43) Pub. Date: Oct. 22, 2009

(54) METHOD FOR BONDING A FIRST COMPONENT TO A SECOND COMPONENT

(75) Inventors: Manfred Kosche, JR., Nubloch (DE); Dirk Scheidle, JR., Selm (DE)

Correspondence Address: HENKEL CORPORATION, One Henkel Way, ROCKY HILL, CT, 06067, US

(73) Assignee: Henkel AG & Co., KGaA, Duesseldorf (DE)

(21) Appl. No.: 12/425,602

(22) Filed: Apr. 17, 2009

(30) Foreign Application Priority Data
Apr. 18, 2008 (DE) 102008019769.6

(51) Int. Cl. B32B 37/12; C09J 163/00

(52) U.S. Cl. 156/275.5

(57) ABSTRACT

A process for bonding a first component to a second component that possesses a border area, with which the first component is overlappingly bonded, wherein a) at least one hot melt adhesive compound deposited on the first component such that said compound comes into contact with the border area of the second component, b) a spot, on which said deposited hot melt adhesive compound comes into contact with the border area, said border area is indirectly or directly locally heated by means of electromagnetic induction to a temperature above the melting point of the hot melt adhesive, c) the first component is contacted with the border area of the second component in such a way that the hot melt adhesive compound comes into contact with the spot of the border area which was heated in step b) such that the hot melt adhesive at the point of contact with the border area melts, and after cooling bonds the first component with the border area of the second component, d) wherein additionally, prior to step b) or after step c), a reactive adhesive is introduced between the first and the second component such that it bonds the first component to the border area of the second component, and e) the reactive adhesive cures or is allowed to cure, wherein, in step a), the hot melt adhesive compound, without being heated, is adhered to the first component using a further adhesive.

This application claims priority, under 35 U.S.C. Section 119, to German Application No. 102008019769.6, filed Apr. 18, 2008, which is incorporated herein by reference in its entirety.

The present invention relates to an improved method for bonding a first component to a second component. In the method, the first component is bonded to the second component with the help of 2 different adhesives. One of the adhesives is a hot melt adhesive, with which the first component is fixed on the second component, before the second adhesive, in the form of a reactive adhesive, cures and produces the final strength of the adhesive bond. Without being heated, the object made of a hot melt adhesive is affixed to the first component with the help of another adhesive. For example, the first component can be a windowpane for a vehicle or a vehicle part, for example the window of a sunroof or a front or rear window. However, the invention is not restricted to these.

A similar method is known, for example, from EP 1 403 108 B1. The explanations furnished therein also apply to the present invention:

“Numerous technological problems are encountered in the glazing of vehicles. Adhesive sealing compounds that are based on polyurethanes and which require a relatively long curing time are typically used for glazing vehicles. Because of the required continuous further transport on a production line during this curing time, the inserted window is subjected to continual vibrations and jolts, which can lead to the window shifting. This type of change in position leads to an imprecise fit and can result in defects in the adhesive sealing joints as well as leakages. In addition, any slipping of the window from its intended position can, at least in some places, reduce the remaining circumferential gap to the bodywork, which would make it impossible to fit a circumferential sealing lip. Moreover, a slipping of the window can also bring about a loss in stability of the vehicle as a whole, as faults in the windows that act as supporting components also affect the structural calculations of the vehicle. Moreover, in particular partially concentrated compression loading of the window during the curing process leads to irregularly cured adhesive surfaces that in an extreme scenario can even lead in places to laterally protruding adhesive sealing compounds. For these reasons many efforts have been made to solve or to circumvent these cited problems.”

Known proposals to solve these problems are cited in the prior art in the introduction of the mentioned document EP 1 403 108 B1. Starting from this, EP 1 403 108 B1 proposes the following improved method for fastening a window on a supporting frame, which is particularly applicable in the direct glazing of vehicles.

“There is used a first adhesive sealing compound, preferably based on polyurethanes, running round the periphery of the main surface of the window in the form of a strand. This can be applied prior to seating the window in the supporting frame either on the window itself or onto the supporting frame. In addition, before seating the window, an additional, second adhesive compound is applied at least in a portion of the total extent of the cited periphery, either on the window or on the supporting frame. Ideally, the first adhesive sealing compound and the second adhesive compound are applied in such a way that after seating the window in the supporting frame they are spatially separated from one another in order to avoid from the outset any possible problems of compatibility. In this connection, the second adhesive compound can be cured more rapidly than the first adhesive sealing compound. “Can be cured more rapidly” is understood here to mean in particular curing times of less than 5 minutes, preferably from 0.5 seconds to 60 seconds, ideally from 0.5 seconds to 5 seconds, wherein the curing of the second adhesive compound can be initiated by a controllable external energy input. In this connection, the lower time limit is solely defined by the boundary conditions of the process and can be arbitrarily short depending on the adhesive compound used, the intensity of the energy input, etc. In any case, the window is initially fixed in the required location solely by the second adhesive compound that cures rapidly and selectively in comparison with the first adhesive sealing compound. This guarantees a trouble-free and homogenous cure of the first adhesive sealing compound. In regard to the durability of the joint produced by the second adhesive compound between the window and supporting frame, the sole requirement here is that it can hold the window in position for long enough until the first adhesive sealing compound is cured. However, the flexibility of the joint produced by the second adhesive compound between the window and supporting frame is to be similarly adjusted to that of the joint produced by the first adhesive sealing compound in the cured state so as to counteract an unwanted neutralization of the long-term flexibility of the adhesive sealing joint afforded by the first adhesive sealing compound.”

“In a particularly advantageous embodiment, a photo-crosslinkable adhesive compound is employed as the second adhesive compound. A photo-crosslinkable adhesive compound is understood to mean, here and below, an adhesive compound that can be cured by irradiation with light in the wavelengths between ca. 300 nm and 780 nm. The sensitivity of such an adhesive compound can thus explicitly encompass the UVA, UVB and/or the visible spectral regions.”

“In another suitable embodiment, a heat-curable adhesive compound is employed as the second adhesive compound. Once the window has been seated in the supporting frame, this adhesive compound is cured by supplying heat. Conventional radiation heaters, infrared lamps or the like can be employed as the heat sources.”

“In a particularly advantageous embodiment, the heat is supplied by a microwave source specifically in the region of the applied second adhesive compound, in order to ensure a uniform heating of the adhesive compound and thereby to institute the homogeneous cure of the corresponding adhesive joint.”

“In a suitable modification of the cited embodiment, a two-component (2K) adhesive compound is employed as the second adhesive compound, which is either coated on the supporting frame or on the window prior to seating the window. After both components have been mixed, this 2K adhesive compound preferably cures in less than 5 minutes, ideally between 5 seconds and 120 seconds. After coating, the cure of the 2K adhesive compound can of course also be further accelerated by heating. Conventional radiation heaters, infrared lamps or the like can be employed as the heat sources.”

“In all the cited embodiments it is advantageous to employ the second adhesive compound in limited areas of the total adhesion surface. Opposing edges and/or (corner) points of the window or of the supporting frame are preferably chosen for this so as to ensure that the second adhesive compound, after curing, adequately fixes the window in the required position, such that this position will no longer be changed e.g. by unavoidable vibrations and shocks in the production line.”

According to this proposed solution in EP 1 403 108 B1, the “second adhesive compound” that is intended to produce a first rapid joint between window and supporting frame is therefore a reactive adhesive. A similar process is also described in EP 1 475 424 A1. Indeed, a hot melt adhesive is used therein as the adhesive compound that is intended to produce a first rapid joint. This can be affixed to several places on the object to be bonded, for example a window, immediately after production of the latter. Consequently, this hot melt adhesive also functions as a spacer during storage and transportation. By this means the modules such as for examples windows can be leant one against the other or be stacked one on top of the other without touching each other and thereby being scratched. The following is stated in the introduction of EP 1 475 424 A1:

“Hot melt adhesives are well known and are widely used for example in the packaging, textile and shoe industries. A hot melt, however, as with all rapidly curing adhesives, such as for example 2-component polyurethane adhesives, involves a rapid build up in strength with a short open time. The jointing must namely occur within the “open time”, meaning that the user has only a very short time in which to deposit the adhesive, to position and join the jointing partner. On exceeding the pot life, adhesion is no longer possible due to insufficient wetting and/or the absence of reactive groups.

“This is particularly very detrimental for adhesively joining large surface areas. Moreover, particularly with metallic substrates or other substrates with good thermal conductivity, this is also disadvantageous.”

“Consequently, hot melts are not used for example as window adhesives in the automobile construction industry. A further important disadvantage of hot melts is that an adhesive bond, due to the thermoplastic behavior of the adhesive, has a tendency to creep and the tensile strength of the adhesive bond decreases strongly, especially at high temperatures. For this reason, adhesive bonds realized with hot melt adhesives are unsuitable for strong dynamic and particularly static loading.

“For this reason, flexible one component polyurethane adhesives are employed in industrial construction, particularly in automobile construction. However, these adhesives have the great disadvantage that they cure slowly. Until the adhesive obtains a sufficiently high inherent strength to be able to hold the adhesion partners in the required position even under pressure and against acting forces, the adhesion partners are usually fixed relative to one another. Wedges or adhesive tapes are often used for such fixations and are removed again after the curing step. The use of these types of fixation aids means both an additional operating expense and a danger that visible surfaces could be damaged.”

Starting from this, EP 1 475 424 A1 describes stackable modules that possess at least one spacer based on a hot melt adhesive binder that is deposited on the surface of the module and adheres to said surface. It is further stated in EP 1 475 424 A1, quote:

“The described modules can be used practically everywhere. Preferred fields of application are machine construction, computer construction, consumer goods construction, particularly household machines, such as for example washing machines, stoves or coffee machines, dishwashers, automobile construction, especially bus-, utility vehicle- and bus or train construction.”

“Modules can be diverse assemblies that themselves are composed of many parts. The complexity of such modules is very varied; for example they can be two partial shells fastened together or they can be modules with thousands of parts. Examples of such modules are cavities for spare wheels, headlamp housings, rear-view mirrors, drivers' cabins, drive units, doors, printed circuit boards, roof modules, etc. All types of windows, particularly roof modules, windscreen modules, rear window modules, side window modules are particularly preferred modules.”

“The primary function of the spacer, due to its spatial extent, is to prevent the direct contact of two surfaces of at least two module surfaces stacked one on top of the other or of laterally touching module surfaces. Such spacers are only expediently placed where it is thought that the module surfaces could come into contact. The place, the number and exact geometry of these spacers depends on the module geometry and is clear to the person skilled in the art how to design them in order to ensure the function of the spacer. In a preferred embodiment, the thickness of the spacer is the same or slightly bigger than the projected thickness of the adhesive between the module and an additional surface being adhesively joined.”

“The spacer is based on a hot melt adhesive binder. The hot melt adhesive binder is preferably free of solvent and is a solid at room temperature. For processing, the binder has to be heated up and converted into a liquid. The melting point of the hot melt adhesive binder as a constituent of the spacer is thus of great importance. This can greatly vary depending on the material of the module. Firstly, care should be taken that the melting point or melting range is not too low. It makes sense that the spacer must not undergo plastic deformation or even melt at the storage or transport temperature because this would drastically impair the protective function of the spacer and at best it would only possibly act as a protective film.”

“On the other hand, the melting temperature should not be too high. On the one hand the materials should not be too strongly degraded by the proposed temperature. Temperatures which are too high can lead to deformations due to thermal expansion; this is particularly pronounced for adhesive joints, in which the materials to be bonded possess greatly different expansion coefficients, such as for example in the combination metal/plastic. Heat-sensitive materials also limit the possible melting temperature of the hot melt adhesive binders that can be used. The upper use temperature is limited, particularly when using plastics. Thus, it is advantageous for example to ensure that the melting temperature of the spacer is below the softening point of the plastic.”

“The melting temperature of the hot melt adhesive binder is preferably between 50° C. and 140° C., especially between 55° C. and 120° C.”

“The hot melt adhesive binder of the spacer is selected such that it exhibits at least a temporary adhesion to the surface of the module and optionally to a surface to be adhesively bonded to the module. The adhesion of the spacers to the substrate is at least high enough that they do not drop off from their own weight and from other forces which occur during stacking and transportation of the modules.”

“From the chemical point of view, basically all known materials from the hot melt adhesive technology can be considered. Ethylene-vinyl acetate copolymers, polyolefins, in particular APAOs (Amorphous Poly-Alpha Olefins), ethylene-ethyl acrylate copolymers, polyamides, polyesters, in particular polycaprolactone polyesters, polyurethane, in particular TPUs (thermoplastic polyurethanes) and poly-caprolactone polyurethanes as well as butadiene-styrene block copolymers, for example, are particularly suitable. Mixtures of these polymers can also be employed, wherein these mixtures can be within the same class or from among the classes.”

“The spacer has to be deposited on a module surface and must adhere to it. The module surface can be made of different materials. Metals and plastics are particularly preferred as the material. The module is usually constructed from different materials. Particularly often the surface of the module is finished. Such a finish can be for example a varnish, a coating or a surface treatment. Examples of these finishing methods are ceramic coatings, powder coatings, anodizing, priming with zinc dust, phosphating, chromating, sol/gel coatings etc.”

“When necessary, the module surface can be pre-treated for a finishing. Such pre-treatments include both chemical as well as physical pre-treatments such as polishing, sand blasting, brushing or the like, or treatment with cleaners, solvents, adhesion promoters, solutions of adhesion promoters or primers.”

“The spacer consists of a hot melt adhesive binder or comprises a hot melt adhesive binder. However, it is advantageous if the hot melt adhesive binder fraction represents an important weight fraction, preferably more than 70 weight %, especially more than 90 weight %, based on the weight of the spacer. Other exemplary constituents can be additives, tackifiers, adhesion promoters, fillers, UV stabilizers, heat stabilizers, biocides, fungicides, pigments etc.”

“The spacer is preferably, at least at the surface, slightly flexible and does not possess any sharp edges”

“In a preferred embodiment, microwave-absorbing materials are constituents of the spacer. In this regard, firstly microwave-absorbing fillers and microwave-absorbing pigments are preferred, such as for example ferrites, cerium oxides, germanium oxides, carbon black, etc. “Nanoparticles” and/or carbon black are particularly preferred. The mean particle size of these microwave-absorbing fillers and microwave-absorbing pigments is preferably less than a micrometer, particularly less than 100 nanometers.”

“The geometry of the spacer in 2-dimensional examples is advantageously rectangular, triangular or trapezoidal in cross section. The spacer can also possess a porous structure.”

“The application of the spacer onto the module can be carried out in different ways. For example, a spacer can be formed by means of an extrusion process or by casting. During processing, a spacer of this type can be heated up by a heat source in the range for creating an adhesive joint with the module surface, in such a way that at least the surface is partially melted or melted, and then attached to the module surface. The partially melted surface of the spacer wets the module surface; cooling the spacer leads to the build up of adhesion. Alternatively, the module surface—at least locally in the region of the planned joint—can also be heated up to a temperature that is at or above the melting point of the spacer. A spacer is then placed on the warm surface. On contacting the warm surface, the contact surface of the spacer partially melts or melts.”

“Having said that, the spacer can also be directly deposited on the module surface, for example by means of a die. The cross section of the spacer is determined by different shapes of the die. Besides bead-shaped spacers, spacers in the form of spots can also be formed.”

“The spacer or the module surface can be heated, for example by means of infrared heaters, the supply of hot air, contact with electric heating elements or storage in the oven. induction heating can be used for appropriate metallic module surfaces.”

“With all the heating methods, however, care must be taken that advantageously the spacer is melted only at the region of the surface to be contacted with the module. This has the advantage that the distance defined by the spacer between two modules is essentially equal for all identical spacers and can be easily predetermined by the size of the employed spacer body. It is particularly important when, as in an embodiment of the invention described below in detail, the spacer on being bonded to the module assumes the function of an adhesive spacer.”

In order to illustrate the method, EP 1 475 424 A1 contains several Figures, in particular FIG. 1. It is clear from this how the spacers made of hot melt adhesive are affixed to the module to be bonded, and in addition how the actual assembly adhesive is applied in the form of an adhesive bead. This is explained in EP 1 475 424 A1 as follows:

“According to FIG. 1, an inventive spacer 1 is not removed on the production line but rather remains in its position on a module 2, here an automobile windscreen. Assembly adhesive 3, e.g. 1K-PU adhesive, is then applied onto the module 2. The assembly adhesive bead 3 is preferably not interrupted by the hot melt spacer 1, but rather encloses it or runs within the spacer 1. In this way, possible future leakages at the joint of the assembly adhesive and the spacer are impossible. Once the assembly adhesive has been applied, the spacers made of hot melt adhesive are melted. In this process the spacers become a hot melt retaining adhesive. This process can be brought about by the most varied energy sources, preferably by IR radiation, hot air supply or particularly preferably by microwave radiation. The hot melt spacer can be melted either before or during the application of the assembly adhesive. The module with assembly adhesive and the spacer with melted on hot melt retaining adhesive is then manually or automatically, e.g. with a robot, incorporated/pressed into the goods to be produced. Both the hot melt retaining adhesive and the assembly adhesive wet the adhesion surface of the matching part. On cooling, the hot melt retaining adhesive quickly solidifies and develops adhesive strength to the substrate. The adhesive strength is then at least great enough to fix the module in place, until the actual assembly adhesive has developed sufficient strength and is able to retain the module permanently in place. Fixation aids such as adhesive tapes, wedges or clamps are no longer needed in this assembly method, thereby offering a decisive advantage. Accordingly, the spacers no longer need to be removed and disposed of but are rather converted into a retaining adhesive. Additional fixation aids are consequently no longer required; this is another great advantage.

According to these embodiments, the hot melt retaining adhesive (i.e. the hot melt adhesive) is melted by heating before bonding the module with the receiving unit. According to the previously cited point from EP 1 475 424 A1, this can “be brought about by the most varied energy sources, preferably by IR radiation, hot air supply or particularly preferably by microwave radiation.” This possesses processing disadvantages. The particularly preferred melting by microwave radiation presupposes that the hot melt adhesive comprises components such as pigments, for example, that can absorb microwave radiation and are thereby heated. These necessary components make the hot melt adhesive more expensive and limit its formulation possibilities. Provided that the microwave-absorbing components are uniformly dispersed in the hot melt adhesive, then it will be heated throughout its whole volume and melt. This softens the total body of the hot melt adhesive thereby making the module more difficult to put in position. To position the microwave-absorbing components solely in the actual peripheries of the hot melt adhesive that are to be melted is technically complex, however and makes the manufacturing process more expensive.

Similar problems are faced when melting the hot melt adhesives by IR radiation or hot air supply. It is also difficult in these cases to limit the melting of the hot melt adhesive to the actual boundary layers to be bonded and consequently to ensure a dimensionally accurate positioning of the component to be bonded.

The not pre-published German patent application DE 102007006881 improves the method of EP 1 475 424 A1 in such a way that the melting of the hot melt adhesive is limited to a boundary region of the hot melt adhesive when bonding the first component with the second component. An uncontrolled softening of more extensive regions or even the whole hot melt adhesive is avoided, thereby facilitating the adhesive bonding of the first component with the second component by an adhesive joint with a predetermined thickness. Furthermore, the hot melt adhesive must not comprise any radiation-absorbing components, as it must not be melted by the effect of radiation.

The invention described in the cited not pre-published German patent application DE 102007006881 is defined as a process for bonding a first component to a second component that possesses a border area, with which the first component is overlappingly bonded, wherein
a) at least one body made of a hot melt adhesive is bonded to the first component such that on bonding the first component to the second component, said body comes into contact with the border area,
b) on at least one spot, on which said deposited body of hot melt adhesive comes into contact with the border area when bonding the first component, said border area is indirectly or directly locally heated by means of electromagnetic induction to a temperature above the melting point of the hot melt adhesive,
c) the first component is contacted with the border area of the second component in such a way that the body of hot melt adhesive comes into contact with the spot of the border area which was heated in step b) such that the hot melt adhesive at the point of contact with the border area melts, and after cooling bonds the first component with the border area of the second component,
d) wherein additionally, prior to step b) or after step c), a reactive adhesive is introduced between the first and the second component such that it bonds the first component to the border area of the second component, and
e) the reactive adhesive cures or is allowed to cure.

Practical experience gained from the use of this process demonstrated that bonding the body of a hot melt adhesive to the first component by partially melting the hot melt adhesive is difficult to automate, particularly when there is a plurality of bodies of hot melt adhesive. The present invention simplifies the process of the not pre-published German patent application DE 102007006881 in that the object made of a hot melt adhesive, without being heated, is affixed to the first component with the help of another adhesive.

Therefore, the subject matter of the present invention consists in a process for bonding a first component to a second component that possesses a border area, with which the first component is overlappingly bonded, wherein
a) at least one body of hot melt adhesive is bonded to the first component such that on bonding the first component to the second component, said compound comes into contact with the border area,
b) on at least one spot, on which said deposited body of hot melt adhesive comes into contact with the border area when bonding the first component, said border area is indirectly or directly locally heated by means of electromagnetic induction to a temperature above the melting point of the hot melt adhesive,
c) the first component is contacted with the border area of the second component in such a way that the body of hot melt adhesive comes into contact with the spot of the border area which was heated in step b) such that the hot melt adhesive at the point of contact with the border area melts, and after cooling bonds the first component with the border area of the second component,
d) wherein additionally, prior to step b) or after step c), a reactive adhesive is introduced between the first and the second component such that it bonds the first component to the border area of the second component, and
e) the reactive adhesive cures or is allowed to cure, wherein, in step a), the body of hot melt adhesive, without being heated, is adhered to the first component with the help of a further adhesive.

In step a) a commercially available one or two component reactive adhesive, for example an adhesive based on cyanoacrylates, acrylates or epoxides, can be used as the additional adhesive for bonding the body of hot melt adhesive with the first component Exemplary suitable adhesives are the following commercial products of the applicant: Teromix® 6700, Loctite Hysol® 3430, Loctite® 480, Loctite Hysol® 9455, Loctite® 3038 and Macroplast® QR 4663.

The essential difference of the process according to the not pre-published German patent application DE 102007006881 and its development according to the present invention to the prior art cited above consists in that at least one point of the periphery of the second component, with which the first component is bonded, is directly or indirectly heated by electromagnetic induction to a temperature above the melting point of the hot melt adhesive. On contacting the first component with its attached bodies of hot melt adhesive with the periphery of the second component, the hot melt adhesive melts at the heated places in a peripheral region, without the whole hot melt adhesive softening. The depth of melting can be controlled by locally heating the peripheral region of the second component to a temperature that is at a predetermined level above the melting point of the hot melt adhesive. The peripheral region of the second component is advantageously heated to a temperature that is about 10 to 30° C. above the melting point of the hot melt adhesive. Electromagnetic induction heating permits the temperature, to which the peripheral region of the second component is heated, to be exactly controlled to ±10° C., even to ±5° C. The temperature to which the peripheral region of the second component is selectively heated and the melting point of the hot melt adhesive are coordinated such that on contact of the hot melt adhesive with the peripheral region, a peripheral layer of the hot melt adhesive melts to a thickness of 1 to 2 mm.

Consequently, no radiation energy is brought to bear on the hot melt adhesive itself with the result that it does not need to comprise components that can absorb radiation energy, such as for example microwave radiation.

Accordingly, in the inventive process the peripheral region is locally heated to a temperature above the melting point of the hot melt adhesive at any points that are in contact or should come into contact with the hot melt adhesive. Thus the hot melt adhesive melts at the boundary region to the surface of the periphery by coming into contact with the heated points of the periphery. The temperatures of the heated points of the peripheral region are above that of the melting point of the hot melt adhesive. Consequently, the hot melt adhesive wets particularly well and after cooling bonds particularly well to the peripheral region. In contrast, the wetting is poorer and the adhesion lower when the hot melt adhesive is initially heated and then brought into contact with the peripheral region whose temperature is below the melting point of the hot melt adhesive. In this case the hot melt adhesive rapidly solidifies without adequately wetting the peripheral region.

Local heating of the peripheral region to a temperature above the melting point of the hot melt adhesive also affords good adhesion of the hot melt adhesive to oiled parts. Firstly, when heated, the oil partially evaporates before it comes into contact with the hot melt adhesive. Secondly, the residual oil is also heated to a temperature above the melting point of the hot melt adhesive. This improves the absorption of the oil into the hot melt adhesive and removes the interface such that the adhesion is not adversely affected.

The dimensions of each surface of the periphery that is heated before, during or after contact with the hot melt adhesive depend on the dimensions of the contact surface of the hot melt adhesive. Generally, for the case of a heated circular area, a diameter in the range of 5 to 20, particularly 8 to 15 mm is sufficient. For polygonal, e.g. quadratic surfaces, this can be correspondingly calculated. With an appropriate power input (preferably between 300 and 1000 watts), heating times between 1 and 10 seconds are generally sufficient to reach a temperature above the melting point of the hot melt adhesive. The hot melt adhesive should be brought into contact with the heated points during or immediately following this heating period. Because little heat is conducted away during this short time span, the heating can be localized very well.

Local heating of the peripheral region can be effected “from below” or “from above”. In this context, “below” means that side of the periphery opposite to the contact surface with the hot melt adhesive. “Above” means the side that comes into contact with the hot melt adhesive. This is particularly true for metallic peripheral regions that are directly heated by electromagnetic induction. When heating “from below”, the inductor is brought to each point on the underneath of the periphery which is opposite to the contact point with the hot melt adhesive. The corresponding point of the periphery is heated from below by electromagnetic induction directly before or as the top side comes into contact with the hot melt adhesive. If the first component is non-metallic and therefore cannot itself be heated by electromagnetic induction, then the local heating of the periphery can also be effected “from above” immediately before or during the contact with the hot melt adhesive. The inductor is then brought to each of the points of the first component that are opposite to the contact points with the hot melt adhesive. When the electromagnetic alternating field is switched on it penetrates the first component as well as the hot melt adhesive without heating them to any great extent, and by electromagnetic induction heats up any points of the periphery that are intended to come into contact or are in contact with the hot melt adhesive. In particular, the latter mode of operation is selected when there is not enough room to move the inductor to the lower side of the periphery. Independently of the chosen mode of operation, preferably as many inductors for local heating of the peripheral regions are provided as the hot melt adhesive bodies on the first component. In this way all hot melt adhesive bodies can be simultaneously bonded to the second component.

Similarly to that also described in EP 1 475 424 A1, the reactive adhesive that is ultimately responsible for the bond strength between the first and second component can be introduced by various ways into the gap between the first and second component. The first alternative consists in that in the step d) the reactive adhesive, prior to step b), is applied on the first component such that on bonding the first component with the second component in step c), it comes into contact with the peripheral area of the second component. This can be done e.g. in the form of an adhesive bead that is applied continuously on each peripheral area of the first component, which on bonding with the second component bears on the latter's peripheral area. Preferably, this adhesive bead is applied such that it goes round the body of the hot melt adhesive without touching it. This corresponds to the method illustrated in FIG. 1 of EP 1 475 424 A1.

As an alternative to this, the reactive adhesive is not applied onto the first component, but rather on the periphery of the second component. This is also best carried out with an adhesive bead that is applied so as to circumvent each of the points of the peripheral region, which will be indirectly or directly inductively heated before the first component is attached and which come into contact with the hot melt adhesive bodies. This alternative is characterized in that as step d), prior to step b) the reactive adhesive is applied on the peripheral area of the second component such that on bonding the first component with the peripheral area of the second component, it comes into contact with the first component, wherein those points of the peripheral area which come into contact with the hot melt adhesive body in the subsequent step c) remain free of reactive adhesive.

A third, although technologically more complex alternative, consists in inserting the reactive hot melt adhesive only after step c) into the remaining gap between the first component and the peripheral area of the second component.

The hot melt adhesive body initially bonded with the first component is shaped in such a way that it exhibits two approximately parallel surfaces, wherein the first parallel surface comes into contact with the first component and the second parallel surface comes into contact with the periphery of the second component. The hot melt adhesive bodies can be manufactured for example by injection into an appropriate shape or by extrusion and cutting. For reasons of simplified production, the hot melt adhesive bodies are preferably in the form of a round or polygonal slab or column. In this context, “slab” is understood to mean an object whose height is less than the diameter of the base. Inversely, a “column” describes an object whose height is equal to or greater than the diameter of the base. The “base” is any surface with which the hot melt adhesive body is adhered to the first component. The slab or column can be for example triangular, quadrangular (especially square or right angled, but also trapezoidal), pentagonal or hexagonal.

The diameter of the base is preferably in the range 5 to 15 mm, particularly in the range 8 to 12 mm. In this context, “diameter” for non-circular bases is understood to mean the longest diagonal of the base. The height of the object is in accordance with the required gap that has to be bridged. Care should be taken here that some height is lost due to the melting of the surface to be bonded to the second component. Therefore the height of the hot melt adhesive body before adhesion should be at least 4 mm. In practice, a height of more than 10 to 20 mm should seldom be necessary, however.

However, the hot melt adhesive bodies can also be approximately hemispherical. The hemisphere can be glued by its base to the first component by means of the additional adhesive. On bonding with the peripheral region of the second component, the corresponding contact point of the hemisphere is flattened, such that the hot melt adhesive, after bonding the first component to the peripheral region of the second component, has approximately the shape of a round slab.

Those hot melt adhesives can be used as the hot melt adhesive, which are known from the prior art and which are described for example in EP 1475 424 A1. For example, the hot melt adhesive can comprise one or more of the following components or consist of them: polyolefin, ethylene vinyl acetate copolymer, ethylene ethyl acrylate copolymer, polyamide, polyester, polyurethane, butadiene styrene block polymer. Those hot melt adhesives described in paragraph [0027] of EP 1 475 424 A1 are preferred. In addition, hot melt adhesives can be considered that comprise one or more of the following components or consist of them:
cycloaliphatic hydrocarbon resin,
copolymer of styrene with isoprene and/or a-methyl styrene, which can be optionally hydrogenated,
hydrogenated polydecene,
copolymer of maleic anhydride with ethylene and/or propylene.

A hot melt adhesive that is particularly suitable for this purpose comprises (in wt. % based on the total hot melt adhesive):
cycloaliphatic hydrocarbon resin in amounts of 20 to 30 wt. %,
copolymer of styrene with isoprene and/or α-methyl styrene, which can be optionally hydrogenated, in amounts of 20 to 40 wt. %
hydrogenated polydecene in amounts of 10 to 20 wt. %
copolymer of maleic anhydride with ethylene and/or propylene in amounts of 25 to 35 wt. %.
In addition, further components can be present in an amount of in total up to 10 wt. %, for example styrene ethylene butylene copolymer that is preferably added in amounts of 1 to 8 wt. %.
Here, the fractions of the individual components add up to 100 wt. %.

Further classes of hot melt adhesives can also be employed in the inventive process:

Exemplary suitable hot melt adhesives can be based on polyesters, polyurethanes, polyolefins, polyacrylates or polyamides. Polyester-based hot melt adhesives are described in EP 028687 for example. These are reaction products of aliphatic, cycloaliphatic or aromatic dicarboxylic acids with aliphatic, cyclic or aromatic polyols. Crystalline or partially crystalline polyesters can be obtained according to the selected carboxylic acids and polyols. Usually dicarboxylic acids are reacted with one another. However, it is also possible to add a fraction of tricarboxylic acids or triols.

Thermoplastic polyurethanes are described as hot melt adhesives in EP 434467 or DE 4128274. These are reaction products of polyols with polyisocyanates, which optionally have an increased modulus. Known polyols based on polyethers, polyesters, polyacrylates, polybutadienes, polyols based on vegetal raw materials or oleochemical polyols can be employed as the polyols. Usually, at least a fraction of aromatic isocyanates is comprised in order to ensure a high reactivity. The properties of the prepolymers, for example the melting point, the flexibility or the adhesion, can be influenced by the choice of the polyols and/or isocyanates. However, reactive thermoplastic polyurethanes are also suitable which can crosslink after application, optionally also permanently.

Additional suitable hot melt adhesives can be polyamides, for example. Exemplary suitable polyamides are described in EP 749463. They are polyamide hot melt adhesives based on dicarboxylic acids and polyether diamines. Particularly suitable hot melt adhesive compositions are described in EP 204 315. They concern polyester amides manufactured on the basis of polymer fatty acids and polyamines.

For example as polyamides those can be selected based on dimer fatty acids-free polyamides. They can be manufactured from
40 to 50 mol %, preferably 50 mol %, of one or more C₄-C₁₈ dicarboxylic acids
5 to 45 mol %, preferably 15 to 40 mol %, of at least one aliphatic diamine
5 to 40 mol %, preferably 20 to 30 mol %, of one or more cycloaliphatic diamines
0 to 40 mol %, preferably 5 to 25 mol % of polyether diamines,
   wherein the sum of the added diamines in a preferred embodiment is 50 mol %, such that dicarboxylic acid components and diamine components are present in approximately equivalent molar fractions.

However, the dicarboxylic acids are preferably added in up to 10% stoichiometric excess with respect to the diamines, such that carboxyl-terminated polyamides result. The molecular weight of the polyamides to be used according to the invention is about 10 000 to 50 000, preferably 15 000 to 30 000. The viscosity of these inventively suitable polyamides is between 5000 and 60 000 mPas, preferably between 15 000 and 50 000 mPas (measured at 200° C., Brookfield Thermosel RVT, EN ISO 2555).

Exemplary dicarboxylic acids for manufacturing the inventive polyamides are especially adipic acid, azelaic acid, succinic acid, dodecanedioic acid, glutaric acid, suberic acid, maleic acid, pimelic acid, sebacic acid, undecanedioic acid or their mixtures.

The diamine component consists essentially of one or more aliphatic diamines, preferably with an even number of carbon atoms, wherein the amine groups are at the ends of the carbon chains. The aliphatic diamines can comprise 2 to 20 carbon atoms, wherein the aliphatic chain can be linear or slightly branched. Practical examples are ethylenediamine, diethylenetriamine, dipropylenetriamine, 1,4-diaminobutane, 1,3-pentanediamine, methylpentanediamine, hexamethylenediamine, trimethyl-hexamethylenediamine, 2-(2-aminomethoxy)ethanol, 2-methypentamethylenediamine, C₁₁-neopentanediamine, diaminodipropylmethylamine, 1,12-diaminododecane. The particularly preferred aliphatic diamines are C₄-C₁₂ diamines with an even number of carbon atoms.

The amino components can also comprise cyclic diamines or heterocyclic diamines such as for example 1,4-cyclohexanediamine, 4,4′-diaminodicyclohexylmethane, piperazine, cyclohexane-bis-(methylamine), isophoronediamine, dimethylpiperazine, dipiperidylpropane, norbornanediamine or m-xylylenediamine.

If the polyamino amide should be more flexible then in addition more polyoxyalkylenediamines can be incorporated such as for example polyoxyethylenediamines, polyoxypropylenediamines or bis-(di-aminopropyl)-polytetrahydrofuran. The polyoxyalkylenediamines are particularly preferred in this respect. Their molecular weight is preferably between 200 and 4000.

In addition, amino carboxylic acids or their cyclic derivatives can be incorporated. 6-Amino hexanoic acid, 11-amino undecanoic acid, laurolactam, ε-caprolactam may be mentioned here.

Another embodiment of the inventively suitable hot melt adhesive comprises a polyamide based on dimerized fatty acid as the essential component. Dimerized fatty acids are obtained by coupling long chain monobasic fatty acids, e.g. linolenic acid or oleic acid. The acids are well known and commercially available.

The inventively useable polyamides are, for example, composed of
35 to 49.5 mol % dimerized fatty acid as well as
0.5 to 15 mol % monomeric fatty acid containing 12 to 22 carbon atoms and
2 to 35 mol % polyether diamine of the general Formula

H₂N—R⁵—O—(R⁶O)x-R⁷—NH₂, (I)
in which
x stands for a number between 8 and 80, particularly between 8 and 40,
R⁵ and R⁷ are the same or different aliphatic and/or cycloaliphatic hydrocarbon groups containing preferably 2 to 8 carbon atoms
R⁶ is an optionally branched aliphatic hydrocarbon group containing 1 to 6 carbon atoms, and
15 to 48 mol % aliphatic diamines containing 2 to 40 carbon atoms, wherein up to 65% of the dimerized fatty acids can be replaced by aliphatic dicarboxylic acids containing 4 to 12 carbon atoms.

Another suitable composition can be obtained from
20 to 49.5 mol % dimerized fatty acid as well as
0.5 to 15 mol % monomeric fatty acid containing 12 to 22 carbon atoms and
20 to 55 mol % of an amine containing 2 to 40 carbon atoms and carrying at least 2 primary amino groups,
   wherein up to 65 % of the dimerized fatty acids can be replaced by aliphatic dicarboxylic acids containing 4 to 12 carbon atoms.

In regard to the amine components in the polyamides, preferably polyether polyols containing primary amino end groups are suitable, as already mentioned above. In this regard, polyether polyols containing amino end groups are preferred which are insoluble or only slightly soluble in water. The employed polyether polyols containing amino end groups have, in particular, molecular weights between 700 and 2500 g/mol. A particularly suitable class of raw materials are for example the bis-(3-aminopropyl)-polytetrahydrofurans.

Moreover, in particular, primary alkylenediamines containing 2 to 10 carbon atoms selected from the abovementioned amines can also be employed

A further suitable class of diamines is derived from the dimer fatty acids and comprises primary amine groups instead of the carboxyl groups. These kinds of substances are often called dimer diamines. They are obtained by forming nitrites from the dimerized fatty acids and subsequent hydrogenation.

The abovementioned aliphatic dicarboxylic acids can be employed as the carboxylic acids. Suitable aliphatic carboxylic acids preferably have 4 to 12 carbon atoms. Up to 65% of the dimer fatty acid can be replaced by these acids. Furthermore, long chain amino carboxylic acids such as 11-amino undecanoic acid or also lauryl lactam can be added.

In this regard, it is known to the person skilled in the art that the melting point of the polyamides can be increased within certain limits by adding sebacic acid. The polyamide raw materials known in fiber chemistry, such as for example caprolactam, can also be added in small amounts. These materials enable the person skilled in the art to increase the melting point within certain limits.

When choosing the monofunctional, difunctional or trifunctional raw materials to be added, one has to take. into account that meltable, i.e. uncrosslinked products are to be obtained. For example, if crosslinking/gelling occurs, then lowering the fraction of trifunctional components (trimer fatty acids) and/or increasing the content of monofunctional amines or fatty acids can result in polymers that do not tend to gel.

In general, the quantities of the amine and the carboxylic acids are selected such that the polyamides contain 1-120 meq carboxyl groups per kg solid, particularly between 10 to 100 meq/kg. Alternatively, an excess of amine can also be used. An amine content between 1-140 meq/kg solid should then be obtained, in particular between 10 to 100 meq/kg. The molecular weight (measured as the number average molecular weight, as obtained using GPC) can range between 30 000 to 300 000 g/mol, in particular between 50 000 to 150 000 g/mol. The viscosity of the polyamides should be between 5000 up to 100 000 mPas (measured at 200° C.), in particular up to 50 000 mPas.

Further suitable systems can consist of copolymers of ethylene and vinyl acetate. These types of copolymers are known and commercially available. They preferably comprise 14-40% vinyl acetate. The melt index is between 25 and 2500.

Furthermore, the inventively suitable hot melt adhesives can comprise additional usual additives. Examples of these are tackifying resins, such as e.g. abietic acid, abietic acid esters, terpene resins, terpene phenol resins or hydrocarbon resins; fillers, such as e.g. silicates, talc, calcium carbonate, clays, carbon black or pigments; antioxidants or stabilizers, e.g. of the sterically hindered phenolic type or the aromatic amine derivatives; fiber-forming additives, such as natural fibers, plastic fibers or glass fibers. Here, the antioxidants can be added in amounts of up to 1.5 wt. % based on the polymer. In general, an inventive hot melt adhesive can comprise up to 15 wt. % in total of these additives.

The hot melt adhesive is chosen such that it melts at a temperature of at least 50° C., particularly at least 55° C., but maximum 220° C., particularly maximum 180° C. In particular, a preferred hot melt adhesive melts above 120° C., particularly in the range 130 to 150° C.

Preferably the hot melt adhesive is harmonized with the reactive adhesive in such a way that after solidifying or curing, both adhesives exhibit a similar, preferably an equal stiffness. Both of the adhesive types then correspond in the load bearing capacity under mechanical loading. At least the stiffness of the hot melt adhesive should not be greater than that of the cured reactive adhesive, as otherwise the hot melt adhesive preferentially gives under loading. This is quite irrelevant for the strength of the bond between the first and second component, but on inspection suggests a “failure”.

An adhesive can be used as the reactive adhesive, which had been previously employed in the prior art for corresponding adhesive bonding of a first component with a second component. As the reactive adhesive, one can use for example a one-component polyurethane adhesive, an epoxy resin adhesive, an acrylate adhesive or sealant or a silicone adhesive or sealant. The reactive adhesive can also be a two-component reaction adhesive.

A single body of hot melt adhesive is not generally sufficient to adequately join the first component with the second component before the reactive adhesive cures. On the other hand, the use of too many bodies of hot melt adhesive is unnecessary and uneconomical. The number of bodies of hot melt adhesive used for the first component depends in particular on its size and weight and should be determined in preliminary tests. In general, it is sufficient to bond 2 to 20, preferably 4 to 16 hot melt adhesive bodies to the first component before bonding it to the second component. When the first component is very large, it may be necessary to apply more than 20 hot melt adhesive bodies per component. The hot melt adhesive bodies are preferably deposited in the area of the opposing corners and/or edges of the first component.

According to the teaching of EP 1 475 424 A1, the hot melt adhesive bodies can be adhered to the first component before this is stored or transported. This means that the manufacturer of the first component can already provide it with the hot melt adhesive bodies before the first component is sent into another production facility, where it is adhesively bonded to the second component. In this case the hot melt adhesive bodies take on the additional function of spacers, as is described in EP 1 475 424 A1.

However, with a view to a rationalized production, it can also be foreseen to apply the hot melt adhesive bodies to the first component immediately before bonding the first component to the second component. In this embodiment, the hot melt adhesive bodies are bonded to the first component in spatial and temporal connection with the bonding of the first component to the second component. This can occur for example whereby the first component prepared for bonding is grasped with a handling device, such as for example a robotic arm, the hot melt adhesive body(ies) is/are then bonded to the first component with the aid of the additional adhesive (which can likewise be effected by a robot) and subsequently, using the same handling device, the first component, without any intermediate storage, is brought into contact with the second component. Adhering the hot melt adhesive body to the first component and bonding the first component to the second component therefore occurs in virtually one production step with the help of the same robot. For this it is required that the additional adhesive, with which the hot melt adhesive bodies are adhered to the first component, cures sufficiently quickly. Of course, the reactive adhesive is likewise applied during this production step either onto the first component or onto the second component or into the gap between the first and second component.

One embodiment of the inventive process is wherein the second component, at least in the border area, is metallic and the border area is directly locally heated by means of electromagnetic induction on at least one spot, on which the deposited hot melt adhesive body comes into contact with the border area when bonding the first component. For this, an alternating magnetic field is applied onto the places of the border areas to be heated.

In an alternative embodiment, the border area of the second component can be indirectly locally heated by means of electromagnetic induction on at least one spot, on which the deposited hot melt adhesive body comes into contact with the border area when bonding the first component, in that an at least partially metallic heating element is at least heated by electromagnetic induction and brought into contact with the border area.

In this embodiment, the alternating magnetic field that produces the electromagnetic induction does not directly act on the border area of the second component in order to heat it. Consequently, this embodiment is not only suitable for second components with a metallic border area, but also for non-metallic second components. In this embodiment, the alternating magnetic field does not directly act on the border area of the second component, but instead acts on a separate heating element that is at least partially metallic. For example, this heating element can be a plastic stud that is provided with a metal foil—at least on the side that is brought into contact with the second component. This metal foil is inductively heated and placed on the border area of the component.

In this connection, a device can be used similarly to that described in more detail in the German Utility publication DE 203 00 624 U1. In this document a device is described that has a so-called “hand tool” that is or comprises an induction appliance. For the inventive process, this device is preferably modified such that one or more corresponding heating devices are provided on the “hand tool”, which are appropriate on the handling device for attaching or setting the first component. For the first process variant, the heating element can be an electromagnetic induction device, with which the metallic border area of the second component is directly heated by electromagnetic induction of currents. In a second embodiment, the heating element likewise comprises a device for electromagnetic induction. In addition, the heating element comprises a metallic element that is heated by electromagnetic induction, and is itself used to locally heat the border area of the second component in that the metallic element is brought into contact with the border area of the second component. In this case a non-metallic elastic stud is preferably provided, which can consist of silicone for example, onto which a metallic foil is brought on the side facing the substrate. This metallic foil is heated by the electromagnetic induction. Due to its elasticity, the stud, when applied to the substrate to be heated, fits snugly to the substrate surface, such that slightly curved substrates can also be locally heated. This mode of operation can be used in particular for bonding the hot melt adhesive body with a non-metallic first or second component. For example, in this way the hot melt adhesive body can be attached to a glass window before this is bonded to a metallic border area of a second component.

The handling device advantageously possesses one or more heating means, with which in step b) the border area of the second component can be indirectly or directly locally heated by means of electromagnetic induction on at least one spot, on which the deposited hot melt adhesive compound comes into contact with the border area when bonding the first component. The handling device preferably comprises as many heating devices as the number of hot melt adhesive bodies bonded to the first component. The same handling device that is applied onto or is inserted into the second component, is also used to inductively heat the border area of the second component at those places onto which the hot melt adhesive bodies are attached, immediately prior to producing the contact. This integrated mode of operation enables particularly short cycle times as only small material areas have to be heated.

The inventive process is not limited to specific first and second components. For example, the first component can be a glass or plastic window, in particular a window of a vehicle. Accordingly, the inventive process is particularly suitable for the direct glazing of vehicles. Moreover, the first component can be a, plastic or wood panel. The first and second component can also be a sheet that should be fixed in place before a flange seam adhesion with a reactive adhesive is applied. This can occur when manufacturing a vehicle door, for example. Furthermore, the inventive process is suitable for adhering solar cell modules in support frames.

The second component can be quite generally a body shell or body shell part of an architectural structure, of a piece of furniture, of an appliance such as for example a domestic or industrial machine or of a vehicle or airplane or of a ship.

The inventive mode of operation can increase production rates in comparison to the prior art. It improves the precision of the adhesive bonding of the first and second components as production tolerances are reduced by better control of the melting of the hot melt adhesive solely in the border area to be bonded.

1. A process for bonding a first component to a second component that possesses a border area, with which the first component is overlappingly bonded, comprising the steps of:
a) at least one hot melt adhesive compound is bonded to the first component such that on bonding the first component to the second component, said compound comes into contact with the border area;
b) on at least one spot, on which said deposited hot melt adhesive compound comes into contact with the border area when bonding the first component, said border area is indirectly or directly locally heated by means of electromagnetic induction to a temperature above the melting point of the hot melt adhesive;
c) the first component is contacted with the border area of the second component in such a way that the hot melt adhesive compound comes into contact with the spot of the border area which was heated in step b) such that the hot melt adhesive at the point of contact with the border area melts, and after cooling bonds the first component with the border area of the second component;
d) wherein additionally, prior to step b) or after step c), a reactive adhesive is introduced between the first and the second component such that the reactive adhesive bonds the first component to the border area of the second component, and
e) the reactive adhesive cures or is allowed to cure; wherein, in step a), the hot melt adhesive compound, without being heated, is adhered to the first component with help from a further adhesive.

2. The process according to claim 1, wherein a one-component or two-component reactive adhesive is used in step a) as the further adhesive.

3. The process according to claim 2, wherein an adhesive based on cyanoacrylates, acrylates or epoxides is used as the further adhesive.

4. The process according to claim 1, wherein as step d), prior to step b) the reactive adhesive is applied on the first component such that on bonding the first component with the second component in step c), the reactive adhesive comes into contact with the border area of the second component.

5. The process according to claim 1, wherein as step d), prior to step b) the reactive adhesive is applied on the border area of the second component such that on bonding the first component with the border area of the second component, the reactive adhesive comes into contact with the first component, wherein those points of the border area which come into contact with the hot melt adhesive compound in the subsequent step c) remain free of said reactive adhesive.

6. The process according to claim 1, wherein as step d), the reactive adhesive of step c) is introduced into a gap between the first component and the border area of the second component.

7. The process according to claim 4, wherein the reactive adhesive is deposited or introduced in the form of an adhesive bead.

8. The process according to claim 1, wherein the hot melt adhesive compound is shaped in such a way that the hot melt adhesive compound exhibits two approximately parallel surfaces, wherein the first parallel surface comes into contact with the first component and the second parallel surface comes into contact with the border area of the second component.

9. The process according to claim 1, wherein the hot melt adhesive comprises one or more of the following components or consists of them: polyolefin, ethylene vinyl acetate copolymer, ethylene ethyl acrylate copolymer, polyamide, polyester, polyurethane, butadiene styrene block polymer.

10. The process according to claim 1, wherein the hot melt adhesive comprises one or more of the following components:
cycloaliphatic hydrocarbon resin;
copolymer of styrene with isoprene and/or α-methyl styrene, which can be optionally hydrogenated;
hydrogenated polydecene;
copolymer of maleic anhydride with ethylene and/or propylene.

11. The process according to claim 1, wherein the reactive adhesive is a one-component polyurethane adhesive, an epoxy resin adhesive, an acrylate adhesive or sealant or a silicone adhesive or sealant or a two-component reactive adhesive.

12. The process according to claim 1, wherein the first component, after bonding with the hot melt adhesive compound(s) and prior to bonding the second component, is stored and/or transported.

13. The process according to claim 1, wherein the first component is grasped with a handling device, the hot melt compound(s) is/are then bonded to the first component and subsequently, using the same handling device, the first component, without any intermediate storage, is brought into contact with the second component.

14. The process according to claim 13, wherein the handling device possesses one or more heating means, with which in step b) the border area of the second component can be indirectly or directly locally heated by means of electromagnetic induction on at least one spot, on which the deposited hot melt adhesive compound comes into contact with the border area when bonding the first component.

15. The process according to claim 1, wherein the second component, at least in the border area, is metallic and the border area is directly locally heated by means of electromagnetic induction on at least one spot, on which the deposited hot melt adhesive compound comes into contact with the border area when bonding the first component.
